(19) United States
(12) Patent Application Publication
(10) Pub. No.: US 2022/0362748 A1
(43) Pub. Date: Nov. 17, 2022

(54) CATALYST IN WHICH CATALYTIC METAL IS SUPPORTED ON HEXAGONAL SUPPORT, AND PREPARATION METHOD THEREFOR

(71) Applicant: Korea Institute of Science and Technology, Seoul (KR)

(72) Inventors: Young Suk JO, Seoul (KR); Jun Young CHA, Seoul (KR); Hyang Soo JEONG, Seoul (KR); Yong Min KIM, Seoul (KR); Hyun Tae SOHN, Seoul (KR); Sung Pil YOON, Seoul (KR); Suk Woo NAM, Seoul (KR); Taik Jin LEE, Seoul (KR); Chang Won YOON, Seoul (KR); Jong Hee HAN, Seoul (KR)

(21) Appl. No.: 17/816,154

(22) Filed: Jul. 29, 2022

Related U.S. Application Data
(63) Continuation of application No. PCT/KR2021/001351, filed on Feb. 2, 2021.

(30) Foreign Application Priority Data
May 7, 2020 (KR) 10-2020-0054538

(51) Int. Cl. B01J 23/46; B01J 27/24; B01J 35/08; B01J 35/02; B01J 35/00; B01J 37/02; B01J 37/08; C01B 3/04; C01B 3/02; C01C 1/04

(52) U.S. Cl. CPC B01J 23/462; B01J 27/24; B01J 35/08; B01J 35/026; B01J 35/0013; B01J 35/023; B01J 37/0201; B01J 37/0236; B01J 37/088; C01B 3/047; C01B 3/025; C01C 1/0411

(57) ABSTRACT

The present invention relates to a catalyst in which a catalytic metal is supported on a support including a single-crystalline hexagonal material, and a preparation method therefor, wherein the catalyst can be effectively used in ammonia dehydrogenation or ammonia synthesis.

### CROSS REFERENCE

This application is a continuation of International Patent Application No. PCT/KR2021/001351, filed Feb. 2, 2021, which claims the benefit of Korean Application No. 20200054538, filed May 7, 2020, each of which is incorporated herein by reference in their entirety for all purposes.

### TECHNICAL FIELD

The present invention relates to a catalyst in which a catalytic metal is supported on a support including a single-crystalline hexagonal material and a preparation method therefor, wherein the catalyst can be effectively used in ammonia dehydrogenation or ammonia synthesis.

### BACKGROUND ART

Due to depletion of fossil energy and environmental pollution, there is a great demand for renewable alternative energy that can replace fossil fuel, and hydrogen is attracting attention as one of such alternative energy.

Fuel cells and hydrogen combustion devices use hydrogen as a reactive gas. To apply fuel cells and hydrogen combustion devices to, for example, automobiles and various electronic products, a stable and continuous hydrogen supply or storage technology is required.

To supply hydrogen to a hydrogen utilization device, a method may be used in which hydrogen is supplied to the device, whenever hydrogen is needed, from a separately installed hydrogen supply section. In this method, compressed hydrogen or liquefied hydrogen may be used for hydrogen storage.

Alternatively, a method may be used in which a material that stores and generates hydrogen is loaded in a hydrogen utilization device, and then hydrogen is generated through reaction of the material and supplied to the hydrogen utilization device. For this method, hydrogen storage techniques such as storage using metal hydride, adsorption, storage using absorbents/carbon, and chemical hydrogen storage have been proposed.

As the material that generates hydrogen, for example, ammonia borane, ammonia, or the like may be used, and a catalyst is used in the process of dehydrogenating the material.

Among others, ammonia has a high hydrogen storage density (about 17.7% by weight) and can be easily synthesized.

For ammonia dehydrogenation and ammonia synthesis, refer to Scheme 1 below.

2NH₃↔3H₂+N₂ΔH=46 kJ/mol [Scheme 1]

As catalysts for ammonia dehydrogenation and ammonia synthesis, catalytic metals supported on supports have previously been studied. However, there is a great need for improving such catalysts in that, for example, the catalytic metals are not well dispersed on the supports, and the catalysts have poor catalytic activity.

In addition, a serious disadvantage of using a support composed of carbon is its susceptibility to hydrogenation under industrial conditions. Specifically, the support composed of carbon is slowly transformed into methane, which results in gradual loss of the support and thus leads to difficulties in operation.

### DISCLOSURE OF INVENTION

### Technical Problem

An object of the present invention is to provide a catalyst for ammonia dehydrogenation or a catalyst for ammonia synthesis, the catalyst having excellent catalytic activity.

An object of the present invention is to provide a catalyst that is stable and does not decompose during ammonia dehydrogenation or ammonia synthesis.

The object of the present invention is not limited to the objects as mentioned above. The object of the present invention will become more clearly understood from the following description, and will be achieved by the means described in the claims and combinations thereof.

### Solution to Problem

A catalyst according to an embodiment of the present invention may comprise a support including a single-crystalline hexagonal material, and a catalytic metal supported on the support.

The single-crystalline material may include one or more selected from the group consisting of hexagonal boron nitride (h-BN), boron nitride nanotubes (BNNTs), boron nitride nanoribbons (BNNRs), boron nitride nanosheets, carbon nanotubes (CNTs), carbon nanofibers (CNFs), reduced graphene oxide (rGO), and silicene.

The catalytic metal may include one or more selected from the group consisting of ruthenium (Ru), nickel (Ni), rhodium (Rh), iridium (Ir), cobalt (Co), iron (Fe), platinum (Pt), chromium (Cr), palladium (Pd), and copper (Cu).

The catalytic metal may be supported in an amount of 0.01% by weight to 3% by weight based on the total weight of the catalyst.

The catalytic metal may include rod-shaped particles, and the rod-shaped particles may have a length of 10 nm to 80 nm and an aspect ratio of 1.2 to 20.

The catalytic metal may include any one or more types of particles selected from the group consisting of hexagonal particles, spherical particles, and semi-spherical particles, and the particles may have a diameter of 2 nm to 40 nm.

The catalyst may have a reaction turnover frequency (TOF) of 7,500 h⁻¹ or higher.

The catalyst may be used in ammonia dehydrogenation or ammonia synthesis.

A preparation method for a catalyst according to an embodiment of the present invention may comprise steps of: impregnating a support including hexagonal boron nitride with a catalytic metal precursor solution; drying the impregnated resultant; and subjecting the dried resultant to heat treatment to obtain a catalyst in which the catalytic metal is supported on the support.

In the preparation method, the dried resultant may be subjected to heat treatment at 200° C. to 700° C.

In the preparation method, the dried resultant may be subjected to heat treatment in an air atmosphere so that the catalytic metal is formed into rod-shaped particles.

In the preparation method, the dried resultant may be subjected to heat treatment in an inert gas atmosphere or a vacuum atmosphere so that the catalytic metal is formed into any one or more types of particles selected from the group consisting of hexagonal particles, spherical particles, and semi-spherical particles.

In the preparation method, the dried resultant may be subjected to heat treatment in an inert gas atmosphere or a vacuum atmosphere so that the catalytic metal is epitaxially grown.

### Advantageous Effects of Invention

The catalyst according to the present invention uses, as a support, hexagonal boron nitride with a large specific surface area, and has a catalytic metal evenly supported thereon, which allows the catalyst to have excellent catalytic activity.

The catalyst according to the present invention uses, as a support, hexagonal boron nitride that is stable and does not decompose under industrial conditions of ammonia dehydrogenation or ammonia synthesis, which allows the catalyst to stably maintain its catalytic activity without a problem of methanation.

In the preparation method for a catalyst according to the present invention, the shape and/or size of the catalytic metal can be controlled by performing heat treatment under specific conditions, which makes it possible to obtain a catalyst having high active sites.

The catalyst according to the present invention has high catalytic activity and turnover frequency, and thus can exert equivalent or improved performance even with a small amount as compared with conventional catalysts.

The catalyst according to the present invention has a very excellent turnover frequency for ammonia decomposition conversion as compared with conventionally known catalysts, and thus can remarkably increase efficiency of hydrogen production.

The effect of the present invention is not limited to the effects as mentioned above. It should be understood that the effect of the present invention includes all effects that can be inferred from the following description.

### BRIEF DESCRIPTION OF DRAWINGS

FIG. 1 illustrates a result obtained by performing XRD analysis on the catalyst according to Example 1 of the present invention.

FIG. 2 illustrates results obtained by measuring ammonia decomposition conversion rates of the catalysts according to Example 1, Example 2, Comparative Example 1, and Comparative Example 2 of the present invention.

FIG. 3A illustrates results obtained by performing TEM analysis on the catalyst according to Example 1 of the present invention. FIG. 3B illustrates results obtained by performing TEM analysis on the catalyst according to Example 2 of the present invention. FIG. 3C illustrates results obtained by performing TEM analysis on the catalyst according to Example 3 of the present invention.

### BEST MODE FOR CARRYING OUT INVENTION

The above-described objects, other objects, features, and advantages of the present invention will be easily understood through the following preferred embodiments with reference to the accompanying drawings. However, the present invention is not limited to the embodiments described herein and may be embodied in other forms. Rather, the embodiments described herein are provided so that the disclosure can be thoroughly and completely understood and the spirit of the present invention can be sufficiently conveyed to those skilled in the art.

In describing each drawing, like reference numerals represent like elements. In the accompanying drawings, dimensions of the structures are enlarged as compared with their actual dimensions for clarity of the present invention. The terms “first”, “second”, and the like may be used to describe various elements; however, the elements should not be limited to such terms. These terms are used only for the purpose of distinguishing one element from another. For example, without departing from the scope of the present invention, a first element may be referred to as a second element, and similarly, the second element may also be referred to as the first element. The singular forms “a”, “an”, and “the” include plural referents unless the context clearly dictates otherwise.

As used herein, the term such as “comprises,” “comprising,” “includes,” “including,” “contains,” “containing,” “has,” or “having” should be understood to imply the inclusion of a stated feature, number, step, operation, element, or part, or combinations thereof, but not the exclusion of one or more other features, numbers, steps, operations, elements, or parts, or combinations thereof. In addition, when a part such as layer, film, region, or plate is said to be “on” another part, it includes not only a case where the part is “directly over” the other part but also a case where there is another part in between. Conversely, when a part such as layer, film, region, or plate is said to be “beneath” another part, it includes not only a case where the part is “directly under” the other part but also a case where there is another part in between.

Unless otherwise specified, it should be understood that all numbers, values, and/or expressions used herein, which represent quantities of ingredients, reaction conditions, polymer compositions, and blends, are modified by the term “about” in all cases, because such numbers are essentially approximations reflecting, among others, various uncertainties in the measurements which arise in obtaining those numbers. In addition, in a case where a numerical range is disclosed herein, such range is continuous, inclusive of both the minimum and maximum values of the range as well as all values between such minimum and maximum values, unless otherwise indicated. Furthermore, in a case where such range is expressed as integers, all integers between and including the minimum and maximum values of the range are included therein, unless otherwise indicated.

The catalyst according to the present invention comprises a support including a single-crystalline hexagonal material, and a catalytic metal supported on the support.

The single-crystalline hexagonal material may include one or more selected from the group consisting of hexagonal boron nitride (h-BN), boron nitride nanotubes (BNNTs), boron nitride nanoribbons (BNNTs), boron nitride nanosheets, carbon nanotubes (CNTs), carbon nanofibers (CNFs), reduced graphene oxide (rGO), and silicene.

More specifically, the single-crystalline hexagonal material may have a two-dimensional plate-like structure. For example, the single-crystalline hexagonal material may include hexagonal boron nitride, boron nitride nanoribbons, boron nitride nanosheets, reduced graphene oxide, and silicene, each of which has a plate-like structure of sheet or flake, with hexagonal boron nitride being preferred.

Two-dimensional materials have been intensively studied in recent years because of new physical and chemical properties that have not been found in conventional bulk materials. Hexagonal boron nitride has a hexagonal shape like graphene and is composed of boron and nitrogen instead of carbon. Thus, this is also called “white graphene.” Hexagonal boron nitride has no dangling bonds on its surface and has a very flat surface, which allows the hexagonal boron nitride to be effectively used as a support for catalytic metals.

The single-crystalline hexagonal material has a large surface area so that a catalytic metal can be evenly dispersed thereon, thereby exhibiting greatly increased catalytic activity. For example, the hexagonal boron nitride has a surface area of 2 m²/g to 50 m²/g.

The hexagonal boron nitride may serve as a thermodynamically stable support. Thus, under industrial conditions of ammonia dehydrogenation or ammonia synthesis, the hexagonal boron nitride neither undergoes methanation nor decomposes, and thus can maintain its shape, characteristics, and the like. Accordingly, the catalyst can stably maintain its catalytic activity.

The catalytic metal may include one or more selected from the group consisting of ruthenium (Ru), nickel (Ni), rhodium (Rh), iridium (Ir), cobalt (Co), iron (Fe), platinum (Pt), chromium (Cr), palladium (Pd), and copper (Cu). Specifically, the catalytic metal may include ruthenium (Ru) when the catalyst is used in ammonia dehydrogenation. Meanwhile, the catalytic metal may further include molybdenum (Mo) when the catalyst is used in ammonia synthesis.

The catalytic metal may be supported in an amount of 0.01% by weight to 3% by weight based on the total weight of the catalyst. In a case where the catalytic metal is used in an amount of lower than 0.01% by weight, supporting thereof itself does not occur or it is difficult to expect increased catalytic activity. Also, in a case where the catalytic metal is used in an amount of higher than 3% by weight, aggregation between the catalytic metals may occur to cause decreased catalytic activity.

The shape and/or size of the catalytic metal may be adjusted depending on an atmosphere in which a heat treatment step in the preparation method to be described later is performed. The details will be described later.

A preparation method for a catalyst according to the present invention comprises steps of: impregnating a support including a single-crystalline hexagonal material with a catalytic metal precursor solution; drying the impregnated resultant; and subjecting the dried resultant to heat treatment to obtain a catalyst in which the catalytic metal is supported on the support. The preparation method for a catalyst may comprise a configuration that substantially overlaps with that for the above-described catalyst, and a detailed description for the overlapping configuration will be omitted.

First, the catalytic metal precursor solution is impregnated on the support. In an exemplary embodiment, when the catalytic metal is ruthenium, the catalytic metal precursor may include RuCl₃, RuCl₃.xH₂O, RuCl₃.3H₂O, [Ru(NH₃)₆]Cl₂, Ru₃(CO)₁₂, C₁₆H₂₂O₂Ru, Ci₈H₂₆Ru, or the like.

Subsequently, the impregnated resultant may be dried. In an exemplary embodiment, the drying may be performed at 40° C. to 100° C. In addition, the impregnated resultant may be vacuum dried.

The dried resultant may be subjected to heat treatment to obtain a catalyst in which the catalytic metal is supported on the support. In an exemplary embodiment, the heat treatment may be performed at a temperature of 200 to 700° C. for 3 to 5 hours. In a case where the temperature is lower than 200° C., the catalytic metal may not be fixed to the surface of the support. Also, in a case where the temperature is higher than 700° C., aggregation between the catalytic metals may occur to cause decreased catalytic activity.

In addition, the heat treatment may be performed in an air atmosphere, an inert gas atmosphere, or a vacuum atmosphere. The inert gas atmosphere may be an argon gas atmosphere, a nitrogen gas atmosphere, or the like.

In a case where the heat treatment is performed in an air atmosphere, the catalytic metal may be formed into rod-shaped particles. The rod-shaped particles may have, but are not limited to, a length of 10 nm to 80 nm and an aspect ratio of 1.2 to 20. As described above, in a case where the catalytic metal is formed into rod-shaped particles, the number of sites having high activity for ammonia decomposition conversion increases.

In a case where the heat treatment is performed in an inert gas atmosphere or a vacuum atmosphere, the catalytic metal may be formed into any one or more types of particles selected from the group consisting of hexagonal particles, spherical particles, and semi-spherical particles. The particles may have, but are not limited to have, a diameter of 2 nm to 40 nm. As described above, in a case where the catalytic metal is formed into any one or more types of particles selected from the group consisting of hexagonal particles, spherical particles, and semi-spherical particles, a catalyst having a relatively high degree of dispersion may be obtained. In addition, the heat treatment in an inert gas atmosphere or a vacuum atmosphere may cause the catalytic metal to be epitaxially grown. Here, the epitaxial growth means that the catalytic metal grows along the framework of the hexagonal structure of the support. The epitaxial growth of the catalytic metal may lead growing of a specific surface or site of the catalytic metal which helps improve ammonia decomposition activity.

Hereinafter, the present invention will be described in more detail by way of examples and experiments, but is not limited to the disclosure below.

### EXAMPLE 1

Hexagonal boron nitride as a support was prepared. The support was impregnated with a mixture of Ru₃CO₁₂, which is a ruthenium precursor, and tetrahydrofuran, and drying was performed at about 40 to 80° C. for about 12 hours. The dried resultant was subjected to heat treatment at 200 to 700° C. for about 3 hours in an air atmosphere, to obtain a catalyst. The catalyst was prepared to contain 1% by weight of ruthenium.

### EXAMPLE 2

A catalyst was prepared in the same manner as in Example 1, except that the dried resultant was subjected to heat treatment in an atmosphere of argon gas that is an inert gas.

### EXAMPLE 3

A catalyst was prepared in the same manner as in Example 1, except that the dried resultant was subjected to heat treatment in a vacuum atmosphere.

### COMPARATIVE EXAMPLE 1

A catalyst was prepared in the same manner as in the above Example, except that silica (SiO₂) was used as a support in place of hexagonal boron nitride and the supported amount of ruthenium was increased to 1.5% by weight.

### COMPARATIVE EXAMPLE 2

A catalyst was prepared in the same manner as in the above Example, except that Al₂O₃ was used as a support in place of hexagonal boron nitride.

### EXPERIMENTAL EXAMPLE 1

### XRD Analysis

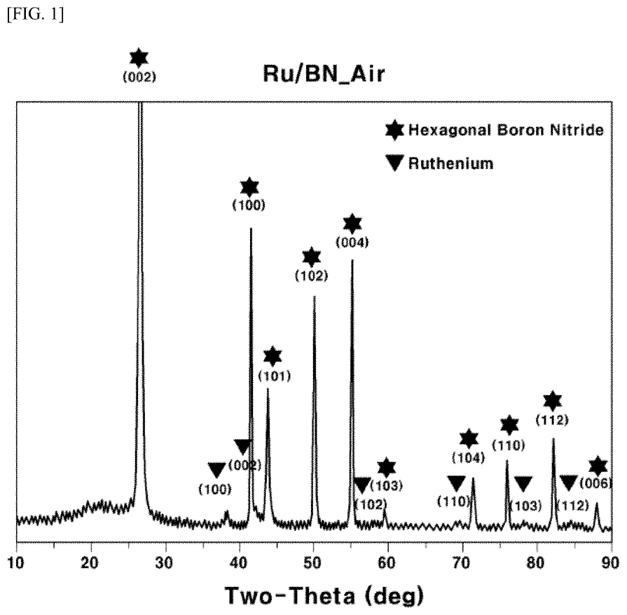

X-ray diffraction analysis was performed on the catalyst according to Example 1. The result is illustrated in FIG. 1. Referring to FIG. 1, it can be seen that ruthenium was properly supported on hexagonal boron nitride as a support because both the peaks of hexagonal boron nitride and ruthenium were observed.

### EXPERIMENTAL EXAMPLE 2

### Measurement of Ammonia Decomposition Conversion Rates Depending on Temperatures

Ammonia dehydrogenation was carried out using the catalysts according to Example 1, Example 2, Comparative Example 1, and Comparative Example 2, and the decomposition conversion rates were measured.

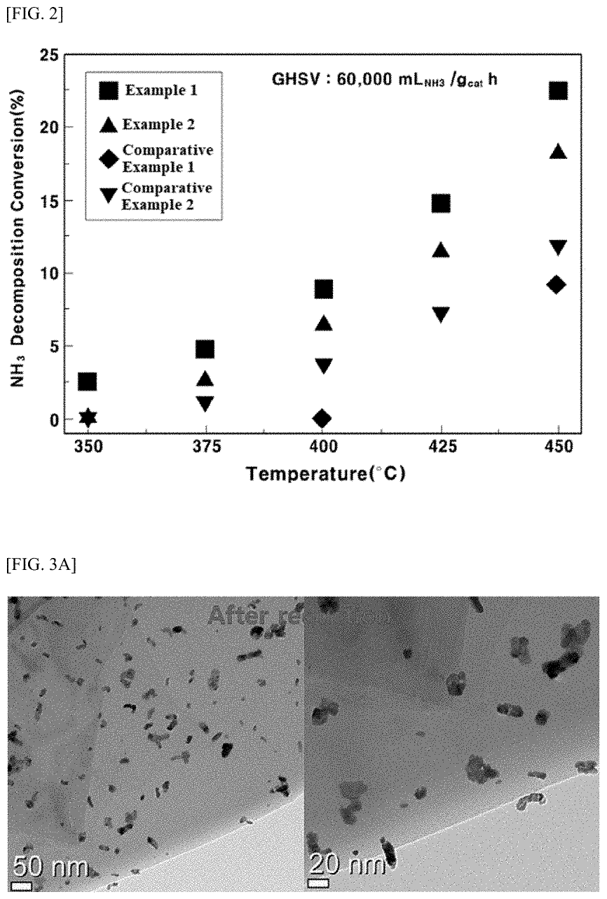

First, 40 mg of each of the catalysts was charged into a packed bed reactor having a diameter of ⅜″. The specific measurement conditions were a temperature of 350 to 450° C., GHSV (NH₃) of 60,000 mL/g_{cat}.h, and a reduction time of 2 hours. The results are illustrated in FIG. 2.

Referring to FIG. 2, it can be seen that Examples 1 and 2 exhibited much higher ammonia decomposition conversion rates as compared with Comparative Examples 1 and 2, even though their supported amount of the catalytic metal is the same as or less than those of Comparative Examples 1 and 2.

### EXPERIMENTAL EXAMPLE 3

### Shape and Size of Catalytic Metal Depending on Atmosphere in which Heat Treatment is Performed

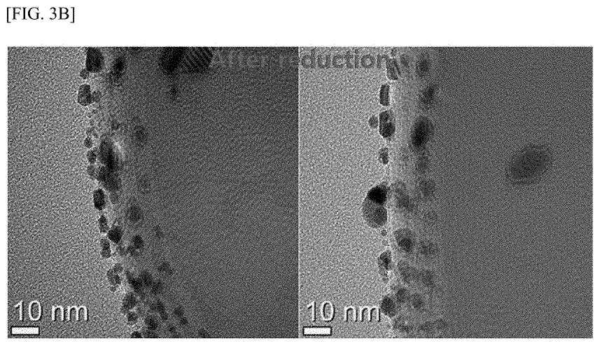

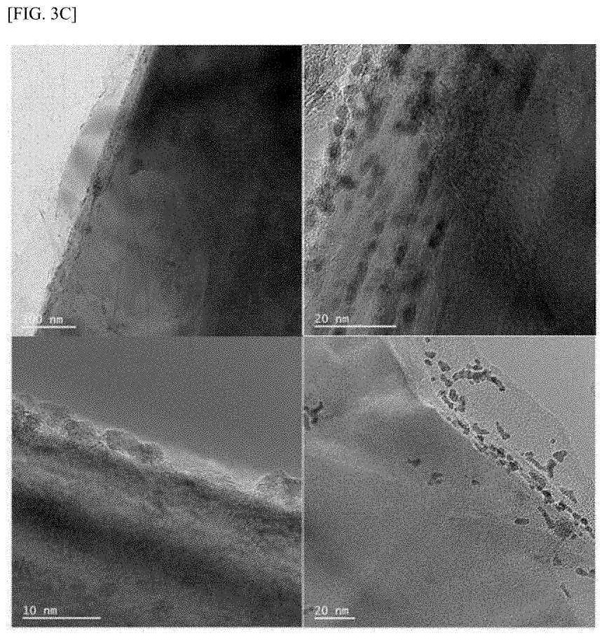

Transmission electron microscope (TEM) analysis was performed on the catalysts according to Examples 1, 2, and 3. The results are illustrated in FIGS. 3A, 3B, and 3C, respectively.

Referring to FIG. 3A, it can be seen that in a case where heat treatment was performed in an air atmosphere, the catalytic metal was formed into rod-shaped particles.

Referring to FIG. 3B, it can be seen that in a case where heat treatment was performed in an inert gas atmosphere, the catalytic metal was formed into hexagonal particles, spherical particles, and semi-spherical particles.

Referring to FIG. 3C, it can be seen that in a case where heat treatment was performed in a vacuum atmosphere, the catalytic metal was formed into spherical particles and semi-spherical particles.

In addition, referring to FIGS. 3B and 3C, it can be seen that in a case where heat treatment was performed in an inert gas atmosphere or a vacuum atmosphere, the catalytic metal was epitaxially grown along the support.

### EXPERIMENTAL EXAMPLE 4

### Calculation of Turnover Frequency (TOF)

Based on the results obtained by measuring the ammonia decomposition conversion rates in Experimental Example 2, the TOF of the catalyst according to the Example was calculated at a condition of 450° C. The results are shown in Table 1.

TABLE 1

| | TOF | |
|---|---|---|
| Item¹⁾ | [h⁻¹] | Literature |
| 1 wt % Ru/h-BN | 9136.9 | Example of present invention |
| 5 wt % K—Ru/MCM-41 | 2473.1 | J. Catal., 236, 2 (2005) 181 |
| 4.4 wt % Ru/Ba(NH₂)₂ | 3691 | J. Phys. Chem. C, 120, 5 (2016) |
| | | 2822 |
| 3.5 wt % Ru/MgO | 4466.9 | Appl B., 211, (2017) 167 |
| 5 wt % Ru/CNT | 1774.6 | Appl. Catal. B., 48, 4 (2004) 237 |
| 5 wt % K—Ru/AC | 3289.3 | Appl. Catal. B., 48, 4 (2004) 237 |
| 5 wt % K—Ru/CNT | 6351.2 | Appl. Catal. B., 48, 4 (2004) 237 |
| 4.8 wt % Ru—KNO₃/CNT | 7191.1 | Appl. Catal. B., 52, (2004) 287 |
| 4.85 wt % | 3121.7 | Catal. Lett., 93, (2004) 113 |
| K—Ru/MgO—CNT | | |
| 5 wt % Ru/Al₂O₃ | 2223 | Commercial catalyst (Sigma- |
| | | Aldrich), 5 wt % Ru/Al₂O₃, |
| | | Cat. #: 439916 |
| 2 wt % Ru/Al₂O₃ | 3193 | KIST (produced in-house) |
| 1.5 wt % SiO₂ | 2518 | KIST (produced in-house) |

¹⁾The left side of the slash (/) indicates the catalytic metal and its supported amount, and the right side thereof indicates the support. Referring to Table 1, it can be seen that the TOF of the catalyst according to the Example of the present invention is remarkably higher than the TOFs of the known catalysts for ammonia dehydrogenation. Therefore, it can be identified that the catalyst according to the present invention has very good efficiency.

Although non-limiting and exemplary embodiments of the present invention have been described above, the technical spirit of the present invention is not limited to the accompanying drawings or the above description. It is apparent to those skilled in the art that various types of modifications can be made within a scope that does not depart from the technical idea of the present invention. In addition, such modifications will fall within the scope of the claims of the present invention.

1. A catalyst for ammonia dehydrogenation or ammonia synthesis, comprising:
a support comprising a single-crystalline hexagonal material; and
a catalytic metal adjacent to the support, and
wherein the catalytic metal comprises one or more types of particles selected from the group consisting of: rod-shaped particles, hexagonal particles, spherical particles, and semi-spherical particles.

2. The catalyst of claim 1, wherein the single-crystalline hexagonal material comprises one or more materials selected from the group consisting of: hexagonal boron nitride (h-BN), boron nitride nanotubes (BNNTs), boron nitride nanoribbons, and boron nitride nanosheets.

3. The catalyst of claim 2, wherein the catalytic metal comprises one or more metals selected from the group consisting of: ruthenium (Ru), nickel (Ni), rhodium (Rh), iridium (Ir), cobalt (Co), iron (Fe), platinum (Pt), chromium (Cr), palladium (Pd), and copper (Cu).

4. The catalyst of claim 1, wherein the single-crystalline hexagonal material comprises hexagonal boron nitride (h-BN).

5. The catalyst of claim 4, wherein the catalytic metal comprises ruthenium (Ru).

6. The catalyst of claim 1, wherein the catalyst comprises the catalytic metal supported in an amount of from 0.01% by weight to 3% by weight of the total weight of the catalyst.

7. The catalyst of claim 1, wherein the catalyst metal comprises rod-shaped particles, wherein the rod-shaped particles have a length of from 10 nm to 80 nm and an aspect ratio of from 1.2 to 20.

8. The catalyst of claim 1, wherein the catalytic metal comprises one or more types of particles selected from the group consisting of: hexagonal particles, spherical particles, and semi-spherical particles, and wherein the particles have a diameter of from 2 nm to 40 nm.

9. The catalyst of claim 1, wherein the catalyst has a reaction turnover frequency (TOF) of 7,500 h⁻¹ or higher.

10. A method of dehydrogenating ammonia using the catalyst of claim 1 comprising:
contacting the ammonia with the catalyst to generate hydrogen and nitrogen.

11. The method of claim 10, wherein the single-crystalline hexagonal material comprises hexagonal boron nitride (h-BN), the catalytic metal comprises ruthenium (Ru), and contacting the ammonia with the catalyst converts the ammonia at a turnover frequency of at least 7500 h⁻¹.

12. A method of synthesizing ammonia using the catalyst of claim 1 comprising:
contacting hydrogen and nitrogen with the catalyst to generate ammonia.

13. A preparation method for a catalyst, comprising:
impregnating a support comprising a single-crystalline hexagonal material with a catalytic metal precursor solution to produce an impregnated resultant;
drying the impregnated resultant to produce a dried resultant; and
subjecting the dried resultant to heat treatment in an air atmosphere or a vacuum atmosphere to obtain a catalyst comprising the catalytic metal supported by the support,
wherein the heat treatment in the air atmosphere or the vacuum atmosphere is performed to adjust at least one of a shape and a size of the catalytic metal.

14. The method of claim 13, wherein the single-crystalline hexagonal material comprises one or more materials selected from the group consisting of: hexagonal boron nitride (h-BN), boron nitride nanotubes (BNNTs), boron nitride nanoribbons (BNNRs), and boron nitride nanosheets.

15. The preparation method of claim 13, wherein the catalytic metal comprises one or more metals selected from the group consisting of: ruthenium (Ru), nickel (Ni), rhodium (Rh), iridium (Ir), cobalt (Co), iron (Fe), platinum (Pt), chromium (Cr), palladium (Pd), and copper (Cu).

16. The preparation method of claim 13, wherein the catalyst comprises the catalytic metal in an amount of from 0.1% by weight to 3% by weight of the total weight of the catalyst.

17. The preparation method of claim 13, wherein the dried resultant is subjected to heat treatment at of from 200° C. to 700° C.

18. The preparation method of claim 13, wherein the dried resultant is subjected to heat treatment in an air atmosphere to form the catalytic metal into rod-shaped particles, wherein the rod-shaped particles have a length of from 10 nm to 80 nm and an aspect ratio of from 1.2 to 20.

19. The preparation method of claim 13, wherein the dried resultant is subjected to heat treatment in a vacuum atmosphere to form the catalytic metal into one or more particles selected from the group consisting of hexagonal particles, spherical particles, and semi-spherical particles, wherein
the particles have a diameter of 2 nm to 40 nm.

20. The preparation method of claim 13, wherein the dried resultant is subjected to heat treatment in a vacuum atmosphere to epitaxially grow the catalytic metal.

21. The preparation method of claim 13, wherein the catalyst has a reaction turnover frequency (TOF) of 7,500 h⁻¹ or higher.
